(19) United States
(12) Patent Application Publication
(10) Pub. No.: US 2024/0403880 A1
(43) Pub. Date: Dec. 5, 2024

(54) AUTHENTICATION FOR AN ACCESS-CONTROLLED RESOURCE

(71) Applicant: Capital One Services, LLC, McLean, VA (US)

(72) Inventors: Erik NEIGHBOUR, Arlington, VA (US); Patrick HERR, Washington, DC (US)

(21) Appl. No.: 18/326,624

(22) Filed: May 31, 2023

(51) Int. Cl. G06Q 20/40; G06Q 20/22

(52) U.S. Cl. CPC G06Q 20/4014; G06Q 20/223; G06Q 20/409

(57) ABSTRACT

In some implementations, a device may obtain information indicating one or more exchanges, of a plurality of exchanges, of a first account associated with a first user that are to be resolved using a peer-to-peer transfer from a second account associated with a second user. The device may transmit a message, designated for a user device associated with the second user, that identifies a link associated with a resource. The device may receive, from a requesting user device, a request to access the resource. The device may determine an authentication of the requesting user device to access the resource. The device may provide, based on the authentication, the resource associated with the link for the requesting user device. The device may receive, from the requesting user device and via the resource, an indication to perform the peer-to-peer transfer, and may cause, based on the indication, the peer-to-peer transfer.

### BACKGROUND

User authentication is usually performed based on credentials. For example, a user may provide a username and password, a personal identification number (PIN), or biometric data in order to gain access to a secure resource (e.g., a web page).

### SUMMARY

Some implementations described herein relate to a system for authentication for an access-controlled resource. The system may include one or more memories and one or more processors communicatively coupled to the one or more memories. The one or more processors may be configured to scan a plurality of exchanges associated with a first account associated with a first user to identify one or more exchanges that satisfy one or more conditions. The one or more processors may be configured to transmit, based on the one or more exchanges being identified, a message that identifies a link associated with a resource, the message designated for an assigned number associated with a user device of a second user associated with a second account. The one or more processors may be configured to receive, from a requesting user device, a request to access the resource made via the link. The one or more processors may be configured to determine an authentication of the requesting user device to access the resource, the authentication based on a registered identifier associated with the assigned number matching a network identifier associated with the requesting user device or the assigned number matching the network identifier. The one or more processors may be configured to provide, based on the authentication, the resource for the requesting user device, the resource indicating information relating to the one or more exchanges. The one or more processors may be configured to receive, from the requesting user device and via the resource, an indication to perform a peer-to-peer transfer from the second account to the first account. The one or more processors may be configured to cause, based on the indication, the peer-to-peer transfer from the second account to the first account.

Some implementations described herein relate to a method of authentication for an access-controlled resource. The method may include obtaining information indicating one or more exchanges, of a plurality of exchanges, of a first account associated with a first user that are to be resolved using a peer-to-peer transfer from a second account associated with a second user. The method may include transmitting a message that identifies a link associated with a resource, the message designated for a user device associated with the second user. The method may include receiving, from a requesting user device, a request to access the resource. The method may include determining an authentication of the requesting user device to access the resource. The method may include providing, based on the authentication, the resource associated with the link for the requesting user device, the resource indicating information relating to the one or more exchanges. The method may include receiving, from the requesting user device and via the resource, an indication to perform the peer-to-peer transfer from the second account to the first account. The method may include causing, based on the indication, the peer-to-peer transfer from the second account to the first account.

Some implementations described herein relate to a non-transitory computer-readable medium that stores a set of instructions. The set of instructions, when executed by one or more processors of a device, may cause the device to obtain information indicating one or more conditions used to identify exchanges of a first account associated with a first user that are to be resolved using a peer-to-peer transfer from a second account associated with a second user. The set of instructions, when executed by one or more processors of the device, may cause the device to scan a plurality of exchanges associated with the first account to identify one or more exchanges that satisfy the one or more conditions. The set of instructions, when executed by one or more processors of the device, may cause the device to cause, based on identification of the one or more exchanges, the peer-to-peer transfer from the second account to the first account, an amount of the peer-to-peer transfer corresponding to an aggregate value of the one or more exchanges.

### BRIEF DESCRIPTION OF THE DRAWINGS

FIGS. 1A-1E are diagrams of an example implementation associated with authentication for an access-controlled resource, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with authentication for an access-controlled resource, in accordance with some embodiments of the present disclosure.

FIG. 4 is a flowchart of an example process associated with authentication for an access-controlled resource, in accordance with some embodiments of the present disclosure.

### DETAILED DESCRIPTION

The following detailed description of example implementations refers to the accompanying drawings. The same reference numbers in different drawings may identify the same or similar elements.

As described herein, a user may provide a credential that can be used to authenticate the user. For example, a user-provided credential may include a username and password, a PIN, a one-time password (OTP), and/or biometric data. In some cases, the user may enter an incorrect password or PIN, may improperly capture biometric data, or the like. As a result, an authentication system may consume computing resources (e.g., processor resources, memory resources, or the like) and/or network resources processing an invalid credential, requesting and receiving a re-entry of a credential, and/or recovering a lost or forgotten credential, among other examples. Moreover, authentication based on a user-provided credential may create a poor user experience and is susceptible to circumvention by malicious actors. In one example, peer-to-peer fund transfers may utilize user authentication and may be subject to the aforementioned issues.

Some implementations described herein enable peer-to-peer transfers using passive authentication. In some implementations, a message identifying a link associated with an access-controlled resource may be transmitted to a user device. The user device may request access to the resource via the link (e.g., when a user clicks or taps the link). To authenticate the user device, an assigned number (e.g., a telephone number) associated with the user device may be translated to a registered identifier (e.g., a subscriber identity module (SIM) identifier, such as an international mobile subscriber identity (IMSI)) for the assigned number. Furthermore, to authenticate the user device, the registered identifier may be compared to a network identifier of the user device (e.g., a SIM identifier or a telephone number) captured in connection with the request to access the resource. The network identifier corresponding to the registered identifier may indicate that the user device requesting access to the resource is the user device that was provided with the link (e.g., and not a different user device to which the link was forwarded or that obtained the link through a data breach or a guessing attack). The resource may include information relating to the one or more exchanges of a first account associated with a first user that are to be resolved (e.g., settled or reimbursed) using a peer-to-peer transfer from a second account associated with a second user. The one or more exchanges may be selected by the first user or automatically identified based on characteristics of the one or more exchanges satisfying one or more conditions.

By using passive authentication of the user device, the user device can be authenticated to access the resource without using user-provided credentials. Accordingly, the authentication is faster, more secure, and less error-prone. In this way, the authentication conserves computing resources (e.g., processor resources, memory resources, or the like) and/or network resources that would have been used processing an invalid credential, requesting and receiving a re-entry of a credential, and/or recovering a lost or forgotten credential, among other examples.

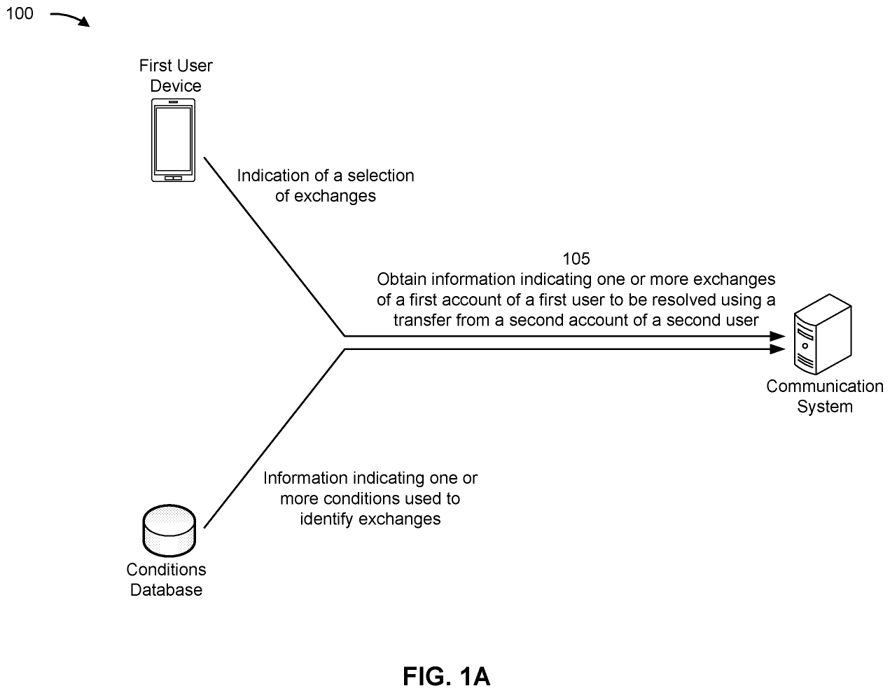

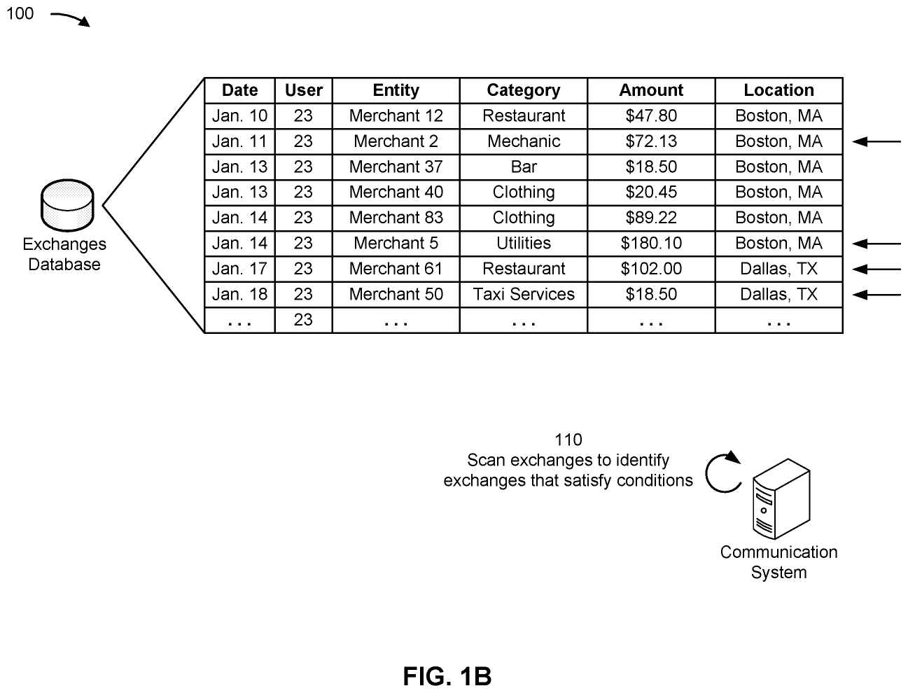

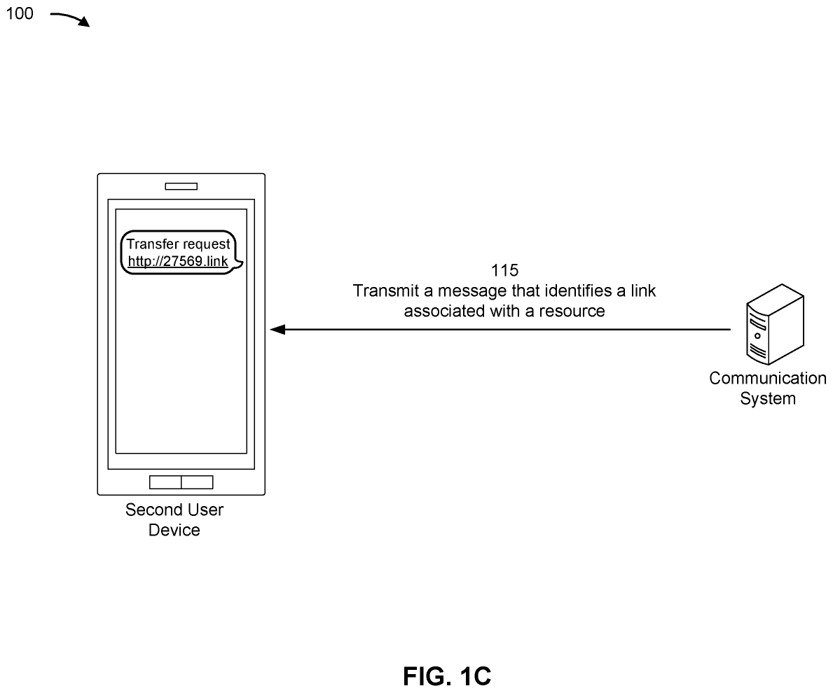

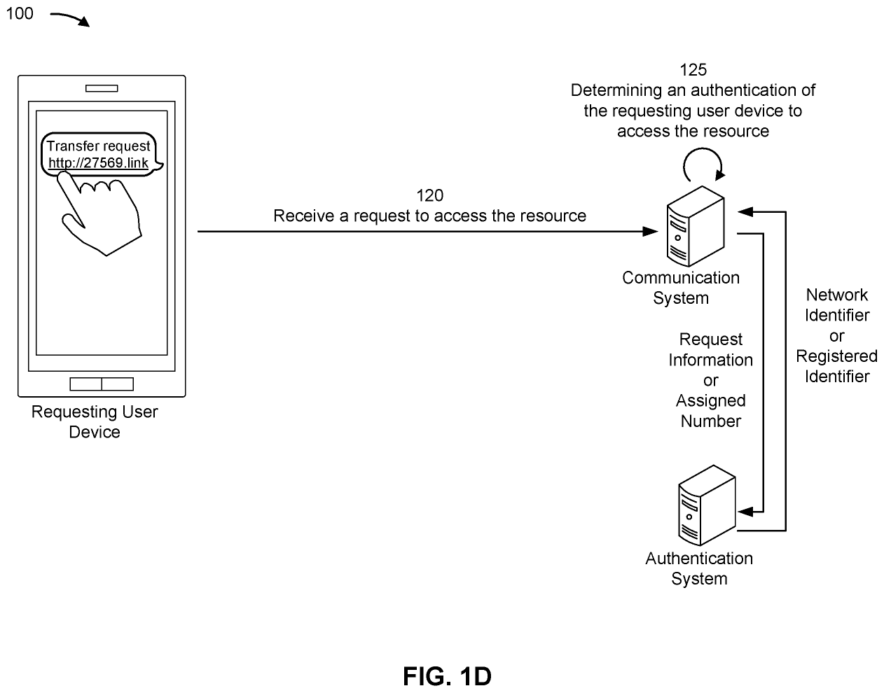

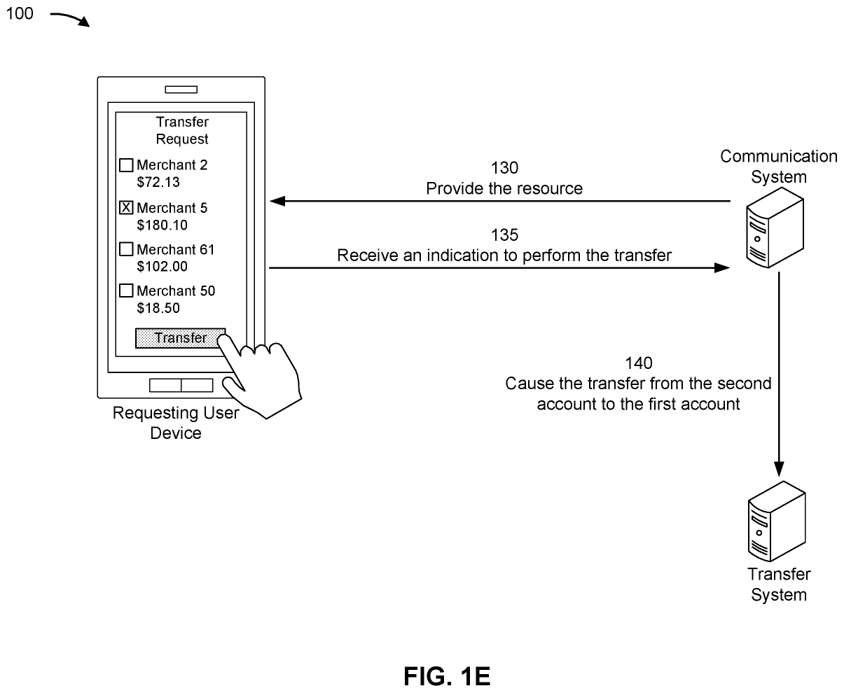

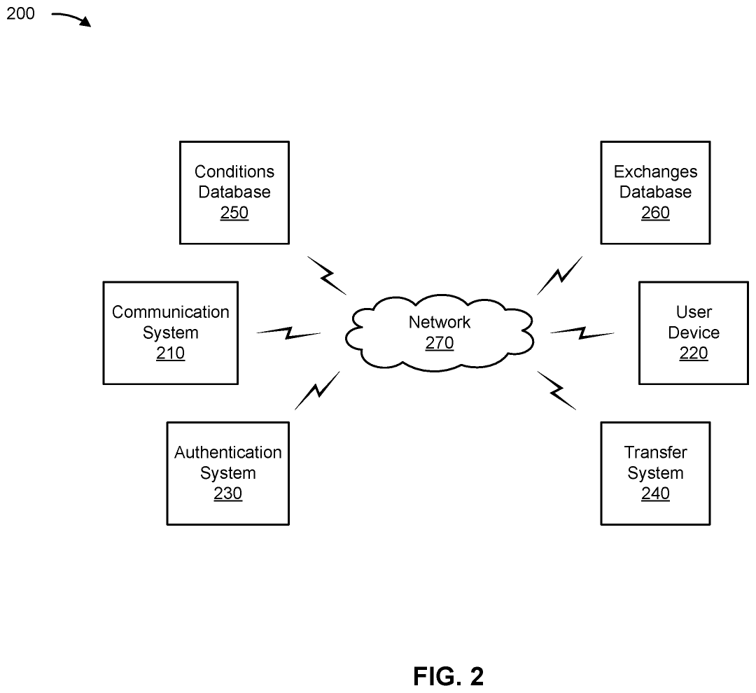

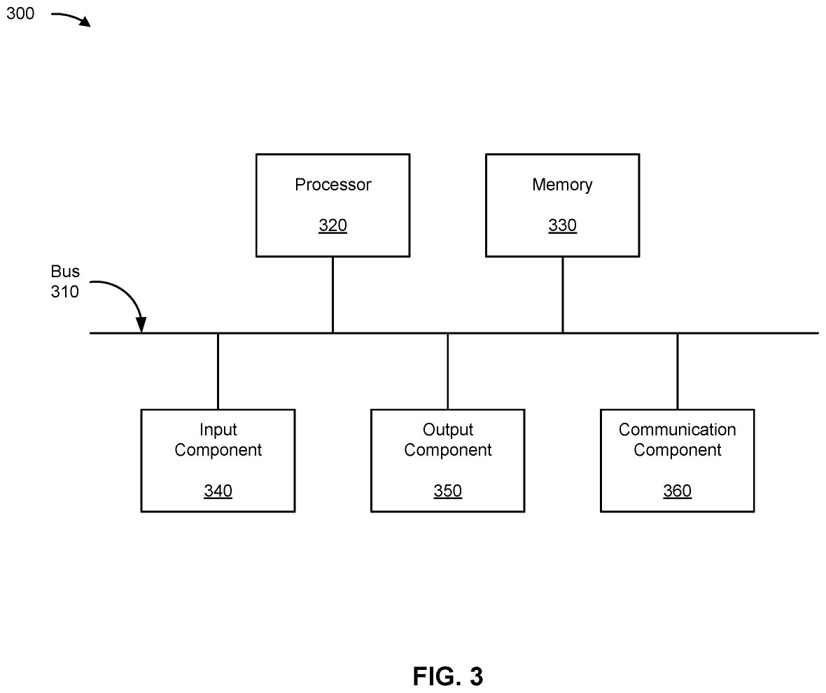

FIGS. 1A-1E are diagrams of an example implementation 100 associated with authentication for an access-controlled resource. As shown in FIGS. 1A-1E, example implementation 100 includes a communication system, one or more user devices (e.g., a first user device, a second user device, and/or a requesting user device), an authentication system, a transfer system, and one or more databases (e.g., a conditions database and/or an exchanges database). These devices are described in more detail below in connection with FIG. 2 and FIG. 3.

The first user device may be associated with a first user that is associated with a first account that is to receive a transfer. The first account may be a transaction card account (e.g., a credit card account) or a deposit account. The second user device may be associated with a second user that is associated with a second account that is to provide a transfer. The second account may be a deposit account. The communication system, the authentication system, the transfer system, and/or the one or more databases may be associated with an entity (e.g., a financial organization) that is to facilitate the peer-to-peer transfer.

As shown in FIG. 1A, and by reference number 105, the communication system may obtain (e.g., retrieve) information indicating one or more exchanges of the first account that are to be resolved (e.g., settled or reimbursed) using a transfer from the second account. For example, a plurality of exchanges may be associated with the first account, and the one or more exchanges may be a subset of the plurality of exchanges. The plurality of exchanges may include transactions between the first user and one or more merchants carried out via a transaction card associated with the first user. In some implementations, to obtain the information indicating the one or more exchanges, the communication system may receive, from the first user device, an indication of a selection of the one or more exchanges from the plurality of exchanges (e.g., a selection of all or less than all of the plurality of exchanges). For example, the communication system may transmit information to the first user device that causes the first user device to present a user interface in which the plurality of exchanges can be viewed, filtered, and/or selected for peer-to-peer transfer. As an example, the first user may provide, via the user interface, an input to the first user device that indicates the selection of the one or more exchanges, and the first user device may transmit an indication of the selection to the communication system. Additionally, or alternatively, the input may indicate a selection of the second user in connection with the transfer to the first account (e.g., the second user may be selected for providing the transfer to the first account using the second account of the second user). In some implementations, the user interface may enable lookup of a user by telephone number or another identifier so that the user can be selected in connection with the transfer to the first account.

In some implementations, to obtain the information indicating the one or more exchanges, the communication system may obtain (e.g., retrieve) information indicating one or more conditions that are used to identify exchanges. For example, the communication system may obtain the information indicating the one or more conditions from the conditions database. The one or more conditions may be particular to the second user, and may have been previously selected or configured by the second user. In some implementations, the information indicating the one or more conditions may also indicate an assigned number (e.g., a telephone number) associated with the second user device and/or an identifier (e.g., a username or user identifier) for a mobile application on the second user device that is configured to communicate with the communication system.

As shown in FIG. 1B, and by reference number 110, the communication system may scan the plurality of exchanges associated with the first account to identify the one or more exchanges that satisfy the one or more conditions. The communication system may obtain the information indicating the conditions and scan the exchanges periodically or responsive to detecting an event (e.g., detecting a new exchange associated with the first account, detecting that an aggregate value of exchanges associated with the first account satisfies a threshold, or the like). To perform the scan, the communication system may compare characteristics of each of the exchanges (e.g., that are new exchanges since a previous scan) to the one or more conditions to identify the one or more exchanges that satisfy the one or more conditions.

The one or more conditions may include a condition that a name of an entity for an exchange corresponds to one or more designated names (e.g., “ABC Book Store” or “Main Street Mechanic”). For example, the one or more designated names may be designated by the first user and/or the second user (e.g., as full names, as partial names with wildcard characters, as regular expressions, or the like). Additionally, or alternatively, the one or more conditions may include a condition that a category associated with an entity for an exchange corresponds to one or more designated categories (e.g., “Utilities” or “Gas Stations”). For example, the one or more designated categories may be designated by the first user and/or the second user. Additionally, or alternatively, the one or more conditions may include a condition that a date associated with an exchange corresponds to one or more designated date ranges (e.g., date ranges associated with travel of the first user, a medical recovery period for the first user, a celebratory event for the first user, or the like). For example, the one or more designated date ranges may be designated by the first user and/or the second user.

Additionally, or alternatively, the one or more conditions may include a condition that a location associated with an exchange corresponds to one or more designated locations (e.g., designated zip codes, cities, states, and/or countries) or is a threshold distance from a residence location associated with the first user. For example, the one or more designated locations and/or the threshold distance may be designated by the first user and/or the second user. In some implementations, the communication system may determine distances between respective locations associated with the plurality of exchanges and the residence location associated with the first user (e.g., the residence location associated with the first user may be stored in account information associated with the first user). Furthermore, the communication system may identify the one or more exchanges based on the distances associated with the one or more exchanges satisfying the threshold distance.

In some implementations, the one or more conditions may relate to a selection preference indicated by the first user and/or the second user. For example, a selection preference may indicate types of exchanges that are to be selected, such as “necessary expenses,” “bills,” or “travel expenses.” Here, the communication system may scan the plurality of exchanges to identify exchanges that satisfy a selection preference. In some implementations, the communication system may determine (e.g., using a mapping, or the like) features that correspond to the selection preference, such as one or more entity names, one or more entity categories, one or more date ranges, one or more locations, and/or one or more threshold distances, among other examples, and the communication system may identify exchanges associated with the features.

In some implementations, the communication system may use a machine learning model trained to classify exchanges as corresponding to one or more selection preferences (e.g., classify exchanges as a “necessary expense” or a “bill”). For example, the machine learning model may be trained using a training set of historical exchanges that are labeled with one or more selection preferences. The training set may indicate a feature set (e.g., variables) for classifying exchanges (e.g., the training set may be structured data). For example, the feature set may include features relating to entity name, entity category, exchange amount, exchange date and/or time, and/or exchange location, among other examples.

As shown in FIG. 1C, and by reference number 115, the communication system (e.g., based on identifying the one or more exchanges) may transmit, to the second user device, a message that identifies a link associated with a resource (e.g., an access-controlled resource). The resource may be a web page, a mobile application user interface, or the like. The link may be a unique link (e.g., unique for the second user device). Moreover, the link may be configured to expire after a particular time period (e.g., the link may include a value that indicates a timestamp, and expiration of the link may be based on the timestamp).

In some implementations, the message may be designated for the assigned number (e.g., telephone number) associated with the second user device. For example, the message may be a text message (e.g., a short message service (SMS) message) that is sent to the assigned number. In some implementations, the message may be designated for the mobile application (e.g., designated for the identifier of the mobile application) on the second user device. For example, the message may be a push notification for the mobile application.

As shown in FIG. 1D, and by reference number 120, the communication system may receive, from a requesting user device, a request to access the resource that is made via the link (e.g., based on the link being clicked, tapped, or the like). The requesting user device may be the second user device, or the requesting user device may be an unknown user device that has acquired the link (e.g., because the second user device forwarded the link to the unknown user device, the unknown user device obtained the link from a data breach, or the unknown user device generated the link using a guessing attack). Thus, the communication system may determine whether the requesting user device is actually the second user device, which is authorized to access the resource, or is an unknown user device that is not authorized to access the resource.

In some implementations, the communication system may cause, or the link may be configured to cause, the requesting user device to switch to a cellular connection (e.g., if the requesting user device is not currently using a cellular connection) to transmit the request to access the resource. For example, a mobile application on the requesting user device may cause the requesting user device to switch to a cellular connection based on an indication from the communication system and/or based on an indication in the link.

By causing the requesting user device to switch to a cellular connection, network information associated with the requesting user device can be captured. For example, the requesting user device may provide an IMSI to a cellular network as part of an initial registration process, and the cellular network may identify a SIM card and associated telephone number of the requesting user device based on the IMSI. This network information may be stored by the cellular network. Furthermore, when the request is made via the link, using the cellular connection, the cellular network may log the requesting user device's IMSI and/or telephone number in a usage record, which may be requested from the cellular network or a third-party provider (e.g., via an application programming interface (API)).

As shown by reference number 125, the communication system may determine an authentication of the requesting user device to access the resource. For example, the communication system may determine whether the requesting user device is the second user device that is authorized to access the resource, or an unknown user device that is not authorized to access the resource. In this way, the authentication maintains the security of the first user's data by preventing the first user's data from being provided to an unapproved device. In some implementations, the request to access the resource may be made via a mobile application, and the request to access the resource may indicate an identifier (e.g., a device token, a registration identifier, a username, or the like) associated with the mobile application. Accordingly, the communication system may determine the authentication based on determining that the identifier is associated with the second user (e.g., associated with the second user device).

In some implementations, the communication system may obtain a network identifier associated with the requesting user device. The communication system may obtain the network identifier based on receiving the request to access the resource (e.g., based on the requesting user device using a cellular connection to transmit the request). In some implementations, the request to access the resource may indicate the network identifier associated with the requesting user device. In some implementations, the communication system may retrieve, from a data source (e.g., the authentication system, as shown), the network identifier associated with the requesting user device (e.g., from a usage record logged by a cellular network, as described herein). For example, to retrieve the network identifier, the communication system may transmit an API request to the authentication system (e.g., a system associated with a cellular network or a third-party provider). The request may indicate identifying information associated with the requesting user device, such as an internet protocol (IP) address, a web browser, an operating system, or the like, associated with the requesting user device. Continuing with the example, the communication system may receive, from the authentication system and responsive to the API request, an API response indicating the network identifier. In some implementations, the communication system may directly capture the network identifier associated with the requesting user device via software (e.g., a mobile application on the requesting user device) configured to access the requesting user device's network information through a browser or an operating system (e.g., using web real-time communications (WebRTC), using JavaScript code in the resource, and/or using an operating system API, among other examples).

The network identifier may be a SIM identifier, such as an IMSI, or a telephone number, associated with the requesting user device. Accordingly, the authentication may be based on a registered identifier (e.g., a SIM identifier, such as an IMSI) associated with the assigned number matching (e.g., being the same as) the network identifier (e.g., a SIM identifier, such as an IMSI) and/or based on the assigned number (e.g., a telephone number) matching (e.g., being the same as) the network identifier (e.g., a telephone number). For example, the communication device may determine the authentication based on the registered identifier associated with the assigned number matching the network identifier and/or based on the assigned number matching the network identifier.

In some implementations, to determine the authentication, the communication system may retrieve, from a data source (e.g., the authentication system, as shown), the registered identifier associated with the assigned number (e.g., a telephone number). For example, to retrieve the registered identifier, the communication system may transmit an API request indicating the assigned number to the authentication system. Continuing with the example, the communication system may receive, from the authentication system and responsive to the API request, an API response indicating the registered identifier (e.g., a SIM identifier, such as an IMSI). The communication system may compare the registered identifier to the network identifier, where a match of the registered identifier and the network identifier (e.g., the registered identifier and the network identifier are the same) indicates the authentication of the requesting user device (e.g., indicates that the requesting user device is the second user device). In some implementations, the API request may further indicate the network identifier, and the API response may indicate an authentication indication as to the authentication of the requesting user device (e.g., the authentication system may perform the comparison).

Additionally, or alternatively, to determine the authentication, the communication system may determine whether a device fingerprint associated with the requesting user device corresponds to a device fingerprint associated with the second user device. A device fingerprint may identify a web browser, an operating system, a screen size, and/or a location (e.g., based on an IP address), among other examples, of a device. A device fingerprint associated with the second user device may be based on one or more previous times that the second user device accessed a resource of the communication system.

In this way, the cryptographic authentication of the requesting user device is passive. For example, a credential does not need to be input to the requesting user device in connection with the authentication. Rather, the authentication uses network information, or other information, associated with the requesting user device to perform the authentication.

As shown in FIG. 1E, and by reference number 130, the communication system may provide the resource for the requesting user device based on the authentication of the requesting user device. In some implementations, the communication system may determine whether the link has expired by determining whether a time difference between a timestamp associated with the link and a current time satisfy a threshold (e.g., 12 hours, 6 hours, or the like). Accordingly, the communication system may provide the resource for the requesting user device based on a determination that the link has not expired. In some implementations, the resource may include a prompt for entering a password (e.g., which can be disclosed to the second user by the first user), and the communication system may provide the resource for the requesting user device based on the password being entered correctly.

The resource (e.g., a web page, a mobile application user interface, or the like) may indicate information relating to the one or more exchanges that are identified from the first account. For example, the resource may include information indicating, for each exchange, an entity associated with the exchange, a category of the exchange, an amount of the exchange, a date of the exchange, and/or a location of the exchange, among other examples. In some implementations, the resource may include one or more user interface elements that enable selection of one or more exchanges for the transfer, that enable declining the transfer, and/or that enable execution of the transfer. Additionally, or alternatively, the resource may include one or more user interface elements that enable linking of the second account for use for the transfer. For example, the communication system may receive, from the requesting user device via the resource (e.g., via the one or more user interface elements), an account number associated with the second account, and the communication system may store information indicating an association between the second user and the account number of the second account.

As shown by reference number 135, the communication system may receive, from the requesting user device and via the resource (e.g., via the one or more user interface elements), an indication to perform the transfer from the second account to the first account. In some implementations, the indication to perform the transfer may further indicate a selection (e.g., by the second user) of a subset (e.g., all or less than all) of the one or more exchanges that are to be resolved using the transfer.

As shown by reference number 140, the communication system may cause the transfer from the second account to the first account. In some implementations, the communication system may cause the transfer based on the indication to perform the transfer received from the requesting user device. In some implementations, the communication system may automatically cause the transfer based on identifying the one or more exchanges. For example, the communication system may scan the plurality of exchanges associated with the first account to identify the one or more exchanges that satisfy the one or more conditions, as described herein, and the communication system may automatically cause the transfer based an identification of the one or more exchanges (e.g., without transmitting the link, providing the resource, or receiving the indication to perform the transfer). By automatically causing the transfer, the communication system eliminates the need to provide the resource to the second user device, thereby maintaining the security of the first user's data.

An amount of the transfer may correspond to an aggregate value of the one or more exchanges. An aggregate value of the one or more exchanges may be a sum of amounts associated with the one or more exchanges. In some implementations, an aggregate value of the one or more exchanges may be a designated percentage of a total value of the one or more exchanges (e.g., the percentage may be 50% if the first user shares the first account with another individual).

In this way, the communication system may permit the requesting user device to access and act on the first user's data via the resource. By using passive authentication of the requesting user device, the requesting user device can be authenticated to access the resource without using user-provided credentials. Accordingly, the authentication is faster, more secure, less error-prone, and conserves computing resources (e.g., processor resources, memory resources, or the like) and/or network resources that would have been used processing an invalid credential, requesting and receiving a re-entry of a credential, and/or recovering a lost or forgotten credential, among other examples.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

FIG. 2 is a diagram of an example environment 200 in which systems and/or methods described herein may be implemented. As shown in FIG. 2, environment 200 may include a communication system 210, a user device 220, an authentication system 230, a transfer system 240, a conditions database 250, an exchanges database 260, and a network 270. Devices of environment 200 may interconnect via wired connections, wireless connections, or a combination of wired and wireless connections.

The communication system 210 may include one or more devices capable of receiving, generating, storing, processing, providing, and/or routing information associated with authentication for an access-controlled resource, as described elsewhere herein. The communication system 210 may include a communication device and/or a computing device. For example, the communication system 210 may include a server, such as an application server, a client server, a web server, a database server, a host server, a proxy server, a virtual server (e.g., executing on computing hardware), or a server in a cloud computing system. In some implementations, the communication system 210 may include computing hardware used in a cloud computing environment.

The user device 220 may include one or more devices capable of receiving, generating, storing, processing, and/or providing information associated with authentication for an access-controlled resource, as described elsewhere herein. The user device 220 may include a communication device and/or a computing device. For example, the user device 220 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The authentication system 230 may include one or more devices capable of receiving, generating, storing, processing, providing, and/or routing information associated with authentication for an access-controlled resource, as described elsewhere herein. The authentication system 230 may include a communication device and/or a computing device. For example, the authentication system 230 may include a server, such as an application server, a client server, a web server, a database server, a host server, a proxy server, a virtual server (e.g., executing on computing hardware), or a server in a cloud computing system. In some implementations, the authentication system 230 may include computing hardware used in a cloud computing environment.

The transfer system 240 may include one or more devices capable of receiving, generating, storing, processing, providing, and/or routing information associated with transfers between accounts, as described elsewhere herein. The transfer system 240 may include a communication device and/or a computing device. For example, the transfer system 240 may include a server, such as an application server, a client server, a web server, a database server, a host server, a proxy server, a virtual server (e.g., executing on computing hardware), or a server in a cloud computing system. In some implementations, the transfer system 240 may include computing hardware used in a cloud computing environment.

The conditions database 250 may include one or more devices capable of receiving, generating, storing, processing, and/or providing information associated with conditions for identifying exchanges, as described elsewhere herein. The conditions database 250 may include a communication device and/or a computing device. For example, the conditions database 250 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the conditions database 250 may store information indicating conditions used to identify exchanges of a first account associated with a first user that are to be resolved using a peer-to-peer transfer from a second account associated with a second user, as described elsewhere herein.

The exchanges database 260 may include one or more devices capable of receiving, generating, storing, processing, and/or providing information associated with exchanges associated with one or more accounts, as described elsewhere herein. The exchanges database 260 may include a communication device and/or a computing device. For example, the exchanges database 260 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the exchanges database 260 may store exchange data identifying exchanges between one or more users and one or more entities, as described elsewhere herein.

The network 270 may include one or more wired and/or wireless networks. For example, the network 270 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 270 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with authentication for an access-controlled resource. The device 300 may correspond to communication system 210, user device 220, authentication system 230, transfer system 240, conditions database 250, and/or exchanges database 260. In some implementations, communication system 210, user device 220, authentication system 230, transfer system 240, conditions database 250, and/or exchanges database 260 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

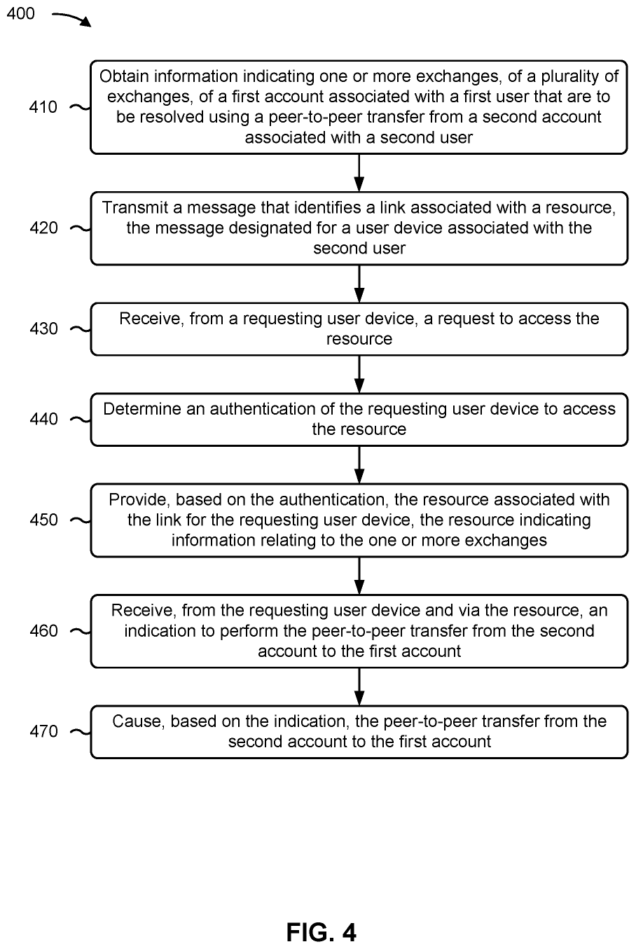

FIG. 4 is a flowchart of an example process 400 associated with authentication for an access-controlled resource. In some implementations, one or more process blocks of FIG. 4 may be performed by the communication system 210. In some implementations, one or more process blocks of FIG. 4 may be performed by another device or a group of devices separate from or including the communication system 210, such as the user device 220, the authentication system 230, and/or the transfer system 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining information indicating one or more exchanges, of a plurality of exchanges, of a first account associated with a first user that are to be resolved using a peer-to-peer transfer from a second account associated with a second user (block 410). For example, the communication system 210 (e.g., using processor 320, memory 330, and/or communication component) may obtain information indicating one or more exchanges, of a plurality of exchanges, of a first account associated with a first user that are to be resolved using a peer-to-peer transfer from a second account associated with a second user, as described above in connection with reference number 105 of FIG. 1A. As an example, the communication system 210 may receive an indication of a selection of the one or more exchanges from the plurality of exchanges, or the communication system 210 may scan the plurality of exchanges associated with the first account to identify the one or more exchanges that satisfy the one or more conditions.

As further shown in FIG. 4, process 400 may include transmitting a message that identifies a link associated with a resource, the message designated for a user device associated with the second user (block 420). For example, the communication system 210 (e.g., using processor 320, memory 330, and/or communication component 360) may transmit a message that identifies a link associated with a resource, the message designated for a user device associated with the second user, as described above in connection with reference number 115 of FIG. 1C. As an example, the message (e.g., a text message or a push notification) may be designated for an assigned number (e.g., telephone number) or a mobile application associated with a user device.

As further shown in FIG. 4, process 400 may include receiving, from a requesting user device, a request to access the resource (block 430). For example, the communication system 210 (e.g., using processor 320, memory 330, and/or communication component 360) may receive, from a requesting user device, a request to access the resource, as described above in connection with reference number 120 of FIG. 1D. As an example, the communication system 210 may cause, or the link may be configured to cause, the requesting user device to switch to a cellular connection (e.g., if the requesting user device is not currently using a cellular connection) to transmit the request to access the resource.

As further shown in FIG. 4, process 400 may include determining an authentication of the requesting user device to access the resource (block 440). For example, the communication system 210 (e.g., using processor 320 and/or memory 330) may determine an authentication of the requesting user device to access the resource, as described above in connection with reference number 125 of FIG. 1D. As an example, the request to access the resource may indicate an identifier (e.g., a device token, a registration identifier, a username, or the like) associated with a mobile application of the requesting user device, and the communication system may determine the authentication based on determining that the identifier is associated with a user (e.g., associated with a user device) that is authorized to access the resource. As another example, the communication system 210 may obtain a network identifier (e.g., a SIM identifier, such as an IMSI, or a telephone number) associated with the requesting user device, and the authentication may be based on a registered identifier (e.g., a SIM identifier, such as an IMSI) associated with the assigned number matching the network identifier, and/or based on the assigned number (e.g., a telephone number) matching the network identifier.

As further shown in FIG. 4, process 400 may include providing, based on the authentication, the resource associated with the link for the requesting user device, the resource indicating information relating to the one or more exchanges (block 450). For example, the communication system 210 (e.g., using processor 320, memory 330, and/or communication component 360) may provide, based on the authentication, the resource associated with the link for the requesting user device, the resource indicating information relating to the one or more exchanges, as described above in connection with reference number 130 of FIG. 1E. As an example, the resource (e.g., a web page, a mobile application user interface, or the like) may indicate information relating to the one or more exchanges of the first account, and the resource may include one or more user interface elements that enable selection of one or more exchanges for the transfer, that enable declining the transfer, and/or that enable execution of the transfer.

As further shown in FIG. 4, process 400 may include receiving, from the requesting user device and via the resource, an indication to perform the peer-to-peer transfer from the second account to the first account (block 460). For example, the communication system 210 (e.g., using processor 320, memory 330, and/or communication component 360) may receive, from the requesting user device and via the resource, an indication to perform the peer-to-peer transfer from the second account to the first account, as described above in connection with reference number 135 of FIG. 1E. As an example, the indication to perform the transfer may further indicate a selection of a subset of the one or more exchanges that are to be resolved using the transfer.

As further shown in FIG. 4, process 400 may include causing, based on the indication, the peer-to-peer transfer from the second account to the first account (block 470). For example, the communication system 210 (e.g., using processor 320, memory 330, and/or communication component 360) may cause, based on the indication, the peer-to-peer transfer from the second account to the first account, as described above in connection with reference number 140 of FIG. 1E. As an example, an amount of the transfer may correspond to an aggregate value of the one or more exchanges (e.g., or a selection thereof).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1E. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for authentication for an access-controlled resource, the system comprising:
one or more memories; and
one or more processors, communicatively coupled to the one or more memories, configured to:
scan a plurality of exchanges associated with a first account associated with a first user to identify one or more exchanges that satisfy one or more conditions;
transmit, based on the one or more exchanges being identified, a message that identifies a link associated with a resource, the message designated for an assigned number associated with a user device of a second user associated with a second account;
receive, from a requesting user device, a request to access the resource made via the link;
determine an authentication of the requesting user device to access the resource, the authentication based on a registered identifier associated with the assigned number matching a network identifier associated with the requesting user device or the assigned number matching the network identifier;
provide, based on the authentication, the resource for the requesting user device, the resource indicating information relating to the one or more exchanges;
receive, from the requesting user device and via the resource, an indication to perform a peer-to-peer transfer from the second account to the first account; and
cause, based on the indication, the peer-to-peer transfer from the second account to the first account.

2. The system of claim 1, wherein the one or more processors, to determine the authentication, are configured to:
retrieve, from a data source, the registered identifier associated with the assigned number; and
compare the registered identifier to the network identifier,
wherein a match of the registered identifier and the network identifier indicates the authentication of the requesting user device.

3. The system of claim 2, wherein the one or more processors, to retrieve the registered identifier, are configured to:
transmit an application programming interface (API) request indicating the assigned number; and
receive, responsive to the API request, an API response indicating the registered identifier.

4. The system of claim 1, wherein the network identifier and the assigned number are telephone numbers.

5. The system of claim 1, wherein the network identifier and the registered identifier are international mobile subscriber identities (IMSIs).

6. The system of claim 1, wherein the one or more conditions include at least one of:
a condition that a name of an entity for an exchange corresponds to one or more designated names,
a condition that a category associated with an entity for an exchange corresponds to one or more designated categories,
a condition that a date associated with an exchange corresponds to one or more designated date ranges, or
a condition that a location associated with an exchange corresponds to one or more designated locations or is a threshold distance from a residence location associated with the first user.

7. The system of claim 1, wherein the one or more processors are further configured to:
receive, from the requesting user device via the resource, an account number associated with the second account; and
store information indicating an association between the second user and the account number.

8. The system of claim 1, wherein the one or more processors are further configured to:
determine whether the link has expired, and
wherein the one or more processors, to provide the resource for the requesting user device, are configured to:
provide the resource for the requesting user device based on a determination that the link has not expired.

9. A method of authentication for an access-controlled resource, comprising:
obtaining information indicating one or more exchanges, of a plurality of exchanges, of a first account associated with a first user that are to be resolved using a peer-to-peer transfer from a second account associated with a second user;
transmitting a message that identifies a link associated with a resource, the message designated for a user device associated with the second user;
receiving, from a requesting user device, a request to access the resource;
determining an authentication of the requesting user device to access the resource;
providing, based on the authentication, the resource associated with the link for the requesting user device, the resource indicating information relating to the one or more exchanges;
receiving, from the requesting user device and via the resource, an indication to perform the peer-to-peer transfer from the second account to the first account; and
causing, based on the indication, the peer-to-peer transfer from the second account to the first account.

10. The method of claim 9, wherein the request is made via an application on the requesting user device, and the request indicates an identifier associated with the application, and
wherein determining the authentication comprises:
determining that the identifier is associated with the second user.

11. The method of claim 9, wherein the message is designated for an assigned number associated with the user device, and
wherein determining the authentication comprises:
obtaining, based on the request to access the resource, a network identifier associated with the requesting user device; and
determining the authentication based on a registered identifier associated with the assigned number matching the network identifier or the assigned number matching the network identifier.

12. The method of claim 11, wherein the assigned number is a telephone number, and
wherein the network identifier and the registered identifier are international mobile subscriber identities (IMSIs).

13. The method of claim 9, wherein the indication to perform the peer-to-peer transfer further indicates a selection of a subset of the one more exchanges that are to be resolved using the peer-to-peer transfer.

14. The method of claim 9, wherein obtaining information indicating the one or more exchanges comprises:
receiving, from a different user device associated with the first user, an indication of a selection of the one or more exchanges from the plurality of exchanges.

15. The method of claim 9, wherein the resource is a web page.

16. The method of claim 9, further comprising:
determining whether the link has expired,
wherein the resource is provided for the requesting user device based on a determination that the link has not expired.

17. A non-transitory computer-readable medium storing a set of instructions, the set of instructions comprising:
one or more instructions that, when executed by one or more processors of a device, cause the device to:
obtain information indicating one or more conditions used to identify exchanges of a first account associated with a first user that are to be resolved using a peer-to-peer transfer from a second account associated with a second user;
scan a plurality of exchanges associated with the first account to identify one or more exchanges that satisfy the one or more conditions; and
cause, based on identification of the one or more exchanges, the peer-to-peer transfer from the second account to the first account, an amount of the peer-to-peer transfer corresponding to an aggregate value of the one or more exchanges.

18. The non-transitory computer-readable medium of claim 17, wherein the one or more conditions include at least one of:
a condition that a name of a party to an exchange corresponds to one or more designated names,
a condition that a category associated with a party to an exchange corresponds to one or more designated categories,
a condition that a date associated with an exchange corresponds to a designated date range, or
a condition that a location associated with an exchange corresponds to one or more designated locations or is a threshold distance from a residence location associated with the first user.

19. The non-transitory computer-readable medium of claim 17, wherein the one or more instructions, when executed by the one or more processors of the device, further cause the device to:
determine distances between respective locations associated with the plurality of exchanges and a residence location associated with the first user; and
identify the one or more exchanges based on the distances associated with the one or more exchanges satisfying a threshold.

20. The non-transitory computer-readable medium of claim 17, wherein the aggregate value of the one or more exchanges is a designated percentage of a total value of the one or more exchanges.
